(19) United States
(12) Patent Application Publication
(10) Pub. No.: US 2015/0353329 A1
(43) Pub. Date: Dec. 10, 2015

(54) Detection, monitoring device of the hook angle and its crane

(71) Applicant: Handing LIN, Fuzhou (CN)

(72) Inventor: Handing LIN, Fuzhou (CN)

(21) Appl. No.: 14/759,935

(22) PCT Filed: Dec. 27, 2013
(86) PCT No.: PCT/CN2013/090644

§ 371 Date: Jul. 9, 2015

(30) Foreign Application Priority Data
Jan. 10, 2013 (CN) 201310008857.3
Apr. 28, 2013 (CN) 201310153481.5

(51) Int. Cl. B66C 13/46; B66C 13/16

(52) U.S. Cl. CPC B66C 13/46; B66C 13/16

(57) ABSTRACT

The present invention provides with a detection and monitoring device of the hook angle and its crane relating to the crane field, wherein between the movable pulley of the lifting pulley assembly of the crane and the hook or between the fixed pulley and the fixed point of the lifting pulley assembly of cranes is cascaded a part, it meets that the plane of the platform fixed on the part is a horizontal plane when the hook angle being 0 degree, so that the action line of the lifting force of the lifting pulley assembly via the hook is perpendicular to the plane of the platform under the different angles of the hook; fixedly install a platform on the part; and provided with the angle measuring instrument on the platform plane. The device provided by the present invention can be used for all types of cranes.

### TECHNICAL FIELD

The present invention relates to the field of cranes, and more particularly relates to a detection and monitoring device of the hook angle using for cranes. The present invention also relates to a crane with the detection and monitoring device of the hook angle.

### TECHNICAL BACKGROUND OF THE INVENTION

Cranes requirements vertical lifting, as stipulated in the construction specification of cranes, the hook angle should not exceed 3 degrees when using a mobile crane lifting the workpiece. However, so far there are no vertical lifting display setting on the cranes, it lead the driver can not determine whether the hook is in a vertical state, and have to conduct by the hoisting commander, but the vertical information of the hanged workpiece provided by the hoisting commander who keep watch on the hanged workpiece is neither timely and accurate steering.

For many years, the detection of the hook angle of cranes is obtained by detecting the angle of the steel rope of the hook or through the machine vision technology to detect the verticality of the hook. In addition, another method that is mentioned in the patent with the application number CN2011103601730 is to directly detect the deviation of the action line of lifting force to the plumb line. In process of lifting, the hook and the lifting pulley assembly of crane have produced the same deviation, and there is a laser generator fixed on the lifting pulley assembly of crane, the light spot in the reflecting surface of the reflector body transmitted by the laser generator, the position corresponding angle value indicate by the concentric circles, and dynamic display declination angle direction and the declination angle degrees of the hook. The patent with the application number CN2011103871994 mentions that on the outside of fender of the movable pulley of the lifting pulley assembly of crane mount a measurement platform with meeting the vertical deviation angle, the measurement platform surface is horizontal, set up the vertical coordinate system in the measurement platform surface, and set the biaxial inclinometer to measure the vertical deviation anile of the X-axis and Y-axis.

There are many style of the lifting pulley assembly relate to the detection of the hook angle, and the part of the lifting pulley assembly is not uniform, the following list of two typical existing pulley hook assembly, FIG. 1 is a schematic view of a lifting pulley assembly setting up two sides of the fender for lifting, In the FIG. 1, 1—fixed pulley, 2—moved pulley, 3—steel rope, 4—fender, 5—hook; FIG. 2 is an schematic view of a lifting pulley assembly additional a board between the lifting pulley assembly and the hook, 1—moved pulley, 2—pulley shaft, 3—fender or shield of the fender, 4—hook, 8—a board added between the lifting pulley assembly and the hook, the hook is fixed on the hook beam 6 by nut 5, a bearing 7 is set between the nut and the hook beam 6.

### SUMMARY OF THE INVENTION

The purpose of the present invention is to prevent oblique hanging, control the deflection of the hook, and provide a detection device of hook that it make the crane can be hoisting vertically and have a large installation space, both for device installation and protection, but also for real-time detection of the hook angle and the addition of co-party display, both for stand-alone lifting, but also for the detection and monitoring of the lifting operation, while creating conditions for installing high-capacity rechargeable battery in the detection device of the hook angle or charging means conditions provided high-capacity rechargeable battery, or creating conditions of a direct power supply device. Another object is to provide a crane comprising said detection and monitoring device of the hook angle. The fender described in present invention is be on both sides of the pulley or connected pulley shaft and the hook beam, can call guards, splints, choke plate, vertical plates and other parts collectively referred to as the fender. FIG. 1 and FIG. 2 are two typical existing pulley hook assembly, and the hook angle, or called the deviation of hoist swing angle is the action line of lifting force of the pulley assembly deviating from the plumb line.

The present invention provides a detection device of the hook angle, which is used for the crane, comprising at least one angle measuring instrument, between the movable pulley of the lifting pulley assembly of crane and the hook or the fixed pulley and the fixed point of the lifting pulley assembly of crane is cascaded a part, and a platform fixed on the part, and the plane of the platform is a horizontal plane when the hook angle is 0 degree, so that the action line of the lifting force of pulley assembly by the hook is perpendicular to the platform plane under the different angle of the hook, for example, between the fixed pulley and the fixed point of the lifting pulley assembly of crane is cascaded a part, the part and the lifting pulley assembly are used the shackle joint and not the welding connection, in order to guarantee the part swing with the hook during the lifting of the crane, at the same time it satisfies that the part permanently installed on the platform plane in the different the hook angle by the lifting force, and fixedly install a platform on the part, the plane of the platform that is a horizontal plane when the hook angle is 0 degree; The plane of platform provided the angle measuring instrument detecting the inclination of the plane of platform to the horizontal plane.

A preferred, the one end of the part is fixed on both sides of the fender of the movable pulley or fixed pulley, because the part is fixedly connected with the movable pulley or fixed pulley, Establishing the coordinates on the platform of the part, based on the respective movable pulley or fixed pulley as a reference, and the movable pulley or fixed pulley relatively clear and direct observation, which is conducive to determine the orientation of the hook angle.

A preferred, when the one end of the part is fixed on both sides of the fender of the fixed pulley, the part is to increasing the length of both sides of the fender of the fixed pulley, and the part is comprised of the increased length of both side of the fender. On the ridge of the fender set up a hanger shaft to install the rings, the rings is used the shackle joint with the fixed point of the lifting pulley assembly of crane, thereby widening the distance between the pulley assembly and the hanger shaft, and providing the space for loading the detection device of the hook angle, between the fixed pulley and the fixed point of the lifting pulley assembly of crane is cascaded a part, and the one end of the part is fixed to the both sides of the fender of the fixed pulley, and respectively increasing the same length of the both sides of the fender so that the platform can fixed on the inside of the vacant position of the increased length of the fender, and the plane of platform is a horizontal plane when the hook angle is 0 degree; on the plane of platform is provided a angle measuring instrument, that simplifying the structure and is conducive to install and protect the detection device of the hook angle, but for the wireless transmission may be one side or both sides of the fender are using non-magnetic glass manufacturing.

A preferred, the detection device of the hook angle can detect the hook angle or output and display the hook by the processing of the microcontroller based on the detection value of the hook angle, the angle measuring instrument can be detected inclination of the platform surface to the horizontal surface; or a biaxial angle sensor for detecting the two-dimensional tilted angle of the plane of platform with respect to the horizontal plane; or a triaxial angle sensor for detecting the three-dimensional tilted angle of the plane of platform with respect to the horizontal plane; or a combination of angle measuring instrument for detecting the tilted angle of the plane of platform with respect to the horizontal plane. When there is a hook angle, the angle between the platform plane and the horizontal plane is ∠A, and ∠A is equal to the vertical deviation angle of lifting pulley assembly of cranes or the hook angle ∠B (shown in FIG. 3, because ∠C=∠D=90°, so ∠A=∠B), the projection of the hook angle in the platform plane that is perpendicular to the intersection line of the platform plane and the horizontal plane. In addition, the hook angel can also be determined by biaxial angle measuring instrument for detecting the inclination of platform plane with respect to the horizontal plane, because the angle between the platform plane and the horizontal plane is numerically equal to the hook angle, because the hook angle is detected only within a few degrees, thus based on the sum of the squares of axial inclination of two-dimensional including X axial and Y axial is approximately equal to the square of the angle of the platform plane with respect to the horizontal plane, and on the basis of the axial inclination values of two-dimensional including X axial and Y axial to output the hook angle or the angel of inclination of the platform plane with respect to the horizontal plane by the microcontroller of the detection device. Similarly, based on the value of the angle between the platform plane and the horizontal plane is equal to the hook angle, it can also be applied triaxial angle measuring instrument, set up the three-axis Cartesian coordinates in the middle of the platform plane and provided a triaxial accelerometer for measuring the inclination angle of platform plane. Through the microcontroller, transform the voltage outputting by the three-axis accelerometer into the output of the angle or the hook angle and display on the LCD. Also based on the value of the angle between the platform plane and the horizontal plane is equal to the hook angle, it will be available for the combination of angle measuring instrument.

A preferred, on the plane of the platform is provided a universal level instrument for detecting the tilted angle of the plane of platform with respect to the horizontal plane; or provided a biaxial angle sensor for detecting the two-dimensional tilted angle of the plane of platform with respect to the horizontal plane; or provided a triaxial angle sensor for detecting the three-dimensional tilted angle of the plane of platform with respect to the horizontal plane; or provided a laser angle measuring instrument for detecting the tilted angle of the plane of platform with respect to the horizontal plane.

Because the value of the angle between the platform plane and the horizontal plane is equal to the hook angle, It assume α, aₓ, a_{y}, respective is the hook angle of the crane or and the axial component of the angle between the platform plane and the horizontal plane of the X axis and Y axis, and it can obtain that: (aₓ)²+(a_{y})²≈(a), the axial angle of the projection of the hook angle deviating from the X axis is βₓ=arctan [(a_{y})/(aₓ)], so it can process by the microcontroller, and output or display the hook angle value and the projection of the hook angle deviating from the X axis on LCD in time. The universal level instrument in this application can detecting the tilted angle of the plane of platform with respect to the horizontal plane; and can directly display, unlike the traditional universal level instrument with bubble display, although the structure is simple cheap, little maintenance, etc., can not be used in motion detection.

A preferred, A monitoring device of the hook angle, which is used for the crane, comprising at least one angle measuring instrument, there have set up a detection device of the hook angle and a wireless transmitting device using for transmitting the signal of the hook angle, and in the crane operator's cab mounted a plurality of receiving device using for receiving and processing the wireless signal and displaying the hook angle; between the movable pulley of the lifting pulley assembly of crane and the hook or the fixed pulley and the fixed point of the lifting pulley assembly of crane is cascaded a part, which is met the plane of the platform fixed on the part is a horizontal plane when the hook angle is 0 degree, so that the action line of the lifting force of the pulley assembly passing over the hook is perpendicular to the plane of the platform under the different angle of the hook; and fixedly install a platform on the part, the plane of the platform that is a horizontal plane when the hook angle is 0 degree; and provided with the angle measuring instrument on the plane of the platform for detecting the inclination of the platform plane from the horizontal plane.

A preferred, the one end of the part is fixed on both sides of the fender of the movable pulley or fixed pulley.

A preferred, between the fixed pulley and the fixed point of the lifting pulley assembly of crane is cascaded a part, and one end of the part is fixed on both sides of the movable pulley, and respectively increasing the same length of the both sides of the fender of the fixed pulley so that the platform can fixed on the inside of the vacant position of the increased length of the fender, and the plane of platform is a horizontal plane when the hook angle is 0 degree; and mounts a wireless transmitting device using for transmitting the signal of the hook angle and a battery to supply the power of the wireless transmitting device.

A preferred, on the plane of the platform is provided a universal level instrument for detecting the tilted angle of the plane of platform with respect to the horizontal plane; or provided a biaxial angle sensor for detecting the two-dimensional tilted angle of the plane of platform with respect to the horizontal plane; or provided a triaxial angle sensor for detecting the three-dimensional tilted angle of the plane of platform with respect to the horizontal plane; or provided a laser angle measuring instrument for detecting the tilted angle of the plane of platform with respect to the horizontal plane.

When the one end of the part is fixed on both sides of the fender of the movable pulley, the part is to increasing the length of both sides of the fender of the movable pulley. On bottom of the fender set up a fixed a beams, the hook still set on both sides of the symmetrical center line of the fender, the hook is fixed to the beam by a nut, thereby widening the distance between the pulley assembly and the hanger shaft, and providing the space for loading the detection device of the hook angle, when the plane of the platform is a horizontal plane when the hook angle is 0 degree or under the different angles, then mounted he detection device inside of the vacant position that is between the both sides of the fender of the movable pulley. There have another plan: A detection device of the hook angle inside of the fender of the movable pulley, which is use for the crane, comprising at least one angle measuring instrument, the hook still set on both sides of the symmetrical center line of the fender, respectively increasing the same length of the both sides of the fender so that a platform can placed on the increased position of the fender plate, and the plane of the platform is a horizontal plane when the hook angle is 0 degree, and provides the angle measuring instrument using for detecting the inclination of the plane of platform to the horizontal plan, that simplifying the structure and is conducive to install and protect the detection device of the hook angle.

A preferred, on the plane of the platform is provided a universal level instrument for detecting the tilted angle of the plane of platform with respect to the horizontal plane; or provided a biaxial angle sensor for detecting the two-dimensional tilted angle of the plane of platform with respect to the horizontal plane; or provided a triaxial angle sensor for detecting the three-dimensional tilted angle of the plane of platform with respect to the horizontal plane; or provided a laser angle measuring instrument for detecting the tilted angle of the plane of platform with respect to the horizontal plane.

A monitoring device of the hook angle inside of the fender of the movable pulley, which is use for the crane, comprising at least one angle measuring instrument, there have set up a detection device of the hook angle and a wireless transmitting device using for transmitting the signal of the hook angle, and in the crane operator's cab mounted a reception control device using for receiving and processing the wireless signal and displaying the hook angle; and respectively increasing the same length of the both sides of the fender of the movable pulley so that the platform can fixed on the inside of the vacant position of the increased length of the fender, and the plane of platform is a horizontal plane when the hook angle is 0 degree; and mounts a wireless transmitting device using for transmitting the signal of the hook angle and a battery to supply the power of the wireless transmitting device, that simplifying the structure and is conducive to install and protect the detection device of the hook angle, but for the wireless transmission may be one side or both sides of the fender are using non-magnetic glass manufacturing.

A preferred, on the plane of the platform is provided a universal level instrument for detecting the tilted angle of the plane of platform with respect to the horizontal plane; or provided a biaxial angle sensor for detecting the two-dimensional tilted angle of the plane of platform with respect to the horizontal plane; or provided a triaxial angle sensor for detecting the three-dimensional tilted angle of the plane of platform with respect to the horizontal plane; or provided a laser angle measuring instrument for detecting the tilted angle of the plane of platform with respect to the horizontal plane.

In the view of the up-lifting and hoisting both single basic operations of mobile cranes, hoisting a lifting requirements in the collaborative, a lifting both sides mutually cooperative party, a lifting of manipulation should take into full consideration, the two sides should be change the comparison of manipulation based on a crane, for which it is necessary to grasp the dynamics of their own hook angle, but also to grasp the dynamics of collaborative party hook declination; especially when the main crane and auxiliary crane of large vertical crane, the speed ratio of the auxiliary crane and the main crane should be equal to the slope of the connection point between the main crane and the auxiliary crane, in order to achieve vertical lifting, and the absolute value of the hook declination produced by the main crane and the auxiliary crane approximately inversely proportional to the load of the main crane or the auxiliary crane. If the load ratio of the main crane and the auxiliary crane is 4:1, when the angel of declination of the main crane is hysteresis 0.75° (difficult to perceive), but the angel of declination of the auxiliary crane is ahead of 30°, at this time if the elevation angle of the large vertical crane is 75° the load undertook by the auxiliary crane is 1.25 times with respect to the hook angle is 0°, and the hook angle of the auxiliary crane reaches the allowable value, the hook angle of the main crane shall meet the requirements, so the driver of the main crane and auxiliary crane shall operate on condition that hook angle displaying by the auxiliary crane is not greater than the permissible value, so it is more necessary to simultaneously display the hook angle of the auxiliary crane in the main and auxiliary operating room timely; In addition, Hoisting the Vertical stuff by the single slip method should be cooperation by the crane to lifting and other machinery to drag in order to achieve vertical lifting, so it is also necessary to dynamic display the hook angle on the collaborative machinery monitoring positions

Due to the independent force points for hoisting is less than or equal to 3, which generally is a two or three cranes to lift, it is possible to design a universal cooperative party monitoring devices for the two or three crane.

A monitoring device of the hook angle adding cooperating display, which is use for the crane, comprising at least one angle measuring instrument, there have set up a detection device of the hook angle and a wireless transmitting device using for transmitting the signal of the hook angle, and in the crane operator's cab mounted a receiving device using for receiving and processing the wireless signal and displaying the hook angle.

(1) respectively increasing the same length of the both sides of the fender of the movable pulley so that the platform can fixed on the inside of the vacant position of the increased length of the fender, and the plane of platform is a horizontal plane when the hook angle is 0 degree the platform can placed on the increased position of the fender, and mounts a two channel wireless transmitting device switched by a remote switch or a three-channel wireless transmitting device switched by remote switch; and provides a battery to supply the power of the wireless transmitting device; and provides the angle measuring instrument using for detecting the inclination of the plane of platform to the horizontal plane, In the crane operator's cab there have fitted with two sets of two channels receiving device matching with the two channel wireless transmitting device; or fitted with three sets of three channels receiving device matching with the three channel wireless transmitting device.

(2) It can prepare a set or more receiving device matching with the wireless transmitting device and with the same switching channel in the crane operator's cab.

The remote switch of the wireless transmitting device is installed in the crane operator's cab.

The three-channel wireless transmission device switching by the remote switch use for three cranes or two cranes to lift the heavy stuff, the two-channel wireless transmission device switching by the remote switch use for two cranes. Each crane is set up a wireless transmitting device and its support of the receiving device according to the monitoring device of the hook angle with co-party display, except for the normal operation of each crane, but can be used for the crane to lifting adding the co-party display.

When the crane is lifting, each crane occupy a channel through the remote switch located in the crane operator's cab, and the receiving device located in the crane operator's cab, except for one receiving device switch to the native channel for dynamically displaying the hook angle outside of the crane operator's cab, and make the other receiving device switch to the cooperating channel for receiving the signal of the cooperating crane and dynamic display the hook angle in the screen of the crane operator's cab.

The receiving device is provided on the monitor location of the lifting with the cooperating party's, or provided on the monitor location of the crane or other machinery without co-party display.

Because the value of the angle between the platform plane and the horizontal plane is equal to the hook angle, the projection of hook angle in the platform plane that is perpendicular to the intersection line of the platform plane and the horizontal plane. the component of the hook angle projecting in the platform plane is located on the X axis and Y axis, and use the positive or negative to display its orientation of the component of hook angle, thus the orientation of the component of hook angle is made the coordinate set up in the platform plane as reference. It also can be equipped with an azimuth measuring instrument by reference to magnetic if you have higher requirements, and to establish the coordinates in the platform plane, provided the angle measuring instrument and the magnetic measuring instrument in order to calculate and detect the direction of the plane rotation angle of the hook to the magnetic north as the initial angle (should make error compensation to rotation angle due to the surrounding magnetic interference), and the measured signal is processed through a wireless transmitting device, and through the microcontroller information processing module to achieve the acquisition and operation of the sensor signal, which will be sent through the data transmission module matching the receiving device installed in the crane operator's cab, and display the hook angle and the azimuth in the LCD in real-time, by observing electronic compass scale provided in crane operator's cab, thus can get the right direction.

The monitoring device of the hook angle and the magnetic azimuth, which is use for the crane, comprising at least one angle measuring instrument, there have set up a detection device of hook angle and a wireless transmitting device using for transmitting the signal of the hook angle and the magnetic azimuth, and in the crane operator's cab mounted a receiving device using for receiving and processing the wireless signal and displaying the hook angle and the magnetic azimuth in real time; and respectively increasing the same length of the both sides of the fender of the movable pulley so that the platform can fixed on the inside of the vacant position of the increased length of the fender, and the plane of platform is a horizontal plane when the hook angle is 0 degree; and provides the angle measuring instrument and a geomagnetic field measuring instrument using for detecting the inclination of the plane of platform to the horizontal plane.

A preferred, the angle measuring instrument set up in the centre of the surface of the lower platform is the three-axis accelerometer; the Installation of geomagnetic field measuring instrument is triaxial geomagnetic field magnetometer, the Z axis of the three-axis accelerometer and three-axis magnetometer lies on a straight line, the X axis and the Y axis of the three-axis accelerometer and three-axis magnetometer parallel to each other.

The crane in this invention, comprising the detection device of the hook angle; or the monitoring device of the hook angle; or the detection device of the hook angle inside of the fender of the movable pulley; or the monitoring device of the hook angle inside of the fender of the movable pulley; or the monitoring device of the hook angle adding cooperating display or the monitoring device of the hook angle and the magnetic azimuth.

The present invention can overcome the requirements for vertical lifting of the during hoisting failed to set the vertical display problems, The purpose of the present invention is to prevent oblique hanging, control the deflection of the hook, and provide a detection device of hook that it make the crane can be hoisting vertically and have a large installation space, both for device installation and protection, but also for real-time detection of hook angle and the addition of co-party display, both for stand-alone lifting, but also for the detection and monitoring device of the lifting operation, and the crane comprising the detection and monitoring of device, then the driver can control the crane eliminating the hook angle to achieve the vertical lifting according to the dynamic display of the hook angle on the screen.

### BRIEF DESCRIPTION OF FIGURES

FIG. 1 is a schematic view of a pulley assembly setting up two sides of the fender for lifting;

FIG. 2 is a schematic view of the lifting pulley assembly with the fender between the pulley assembly and the hook;

FIG. 3 is the explaining view of the detection principle of the vertical deviation of the hook:

FIG. 4 is a schematic view of the implement structural of the present invention;

FIG. 5 is a schematic view of the special bubble level displaying the hook angle in real-time;

FIG. 6 a block diagram of the wireless acquisition of the hook angle with biaxial angle sensor;

FIG. 7 is a schematic view of the laser dynamics displaying of the hook angle;

FIG. 8 is a schematic view of the first plan to increase the length of the fender;

FIG. 9 is a schematic view of the second plan to increase the length of the fender;

FIG. 10 is a schematic view of the plan to cascade a part.

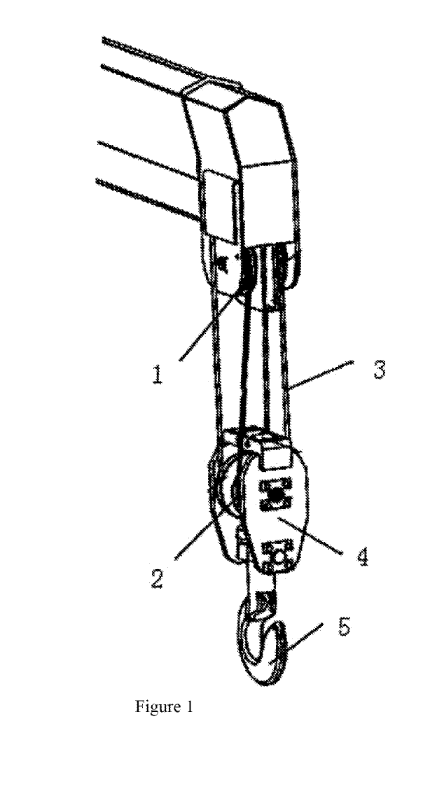

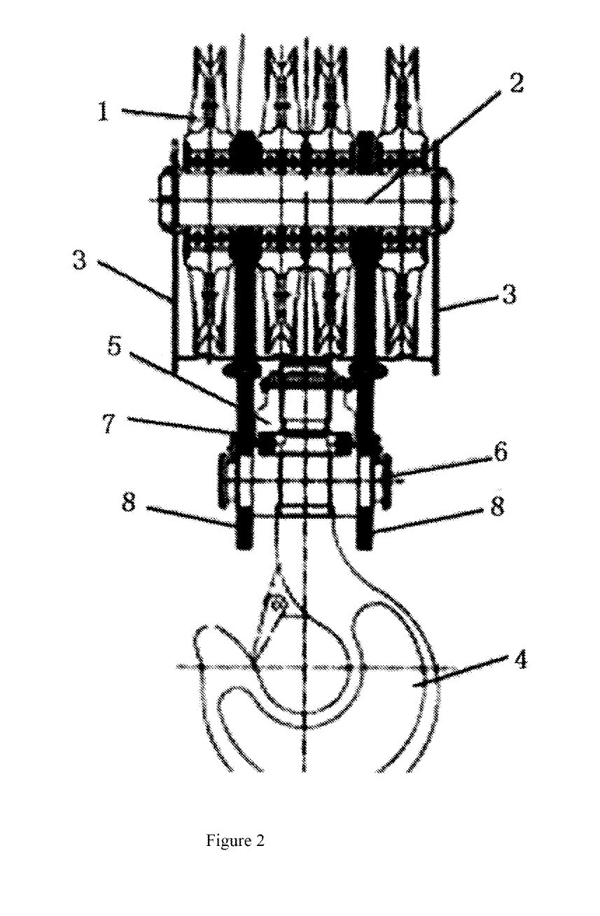

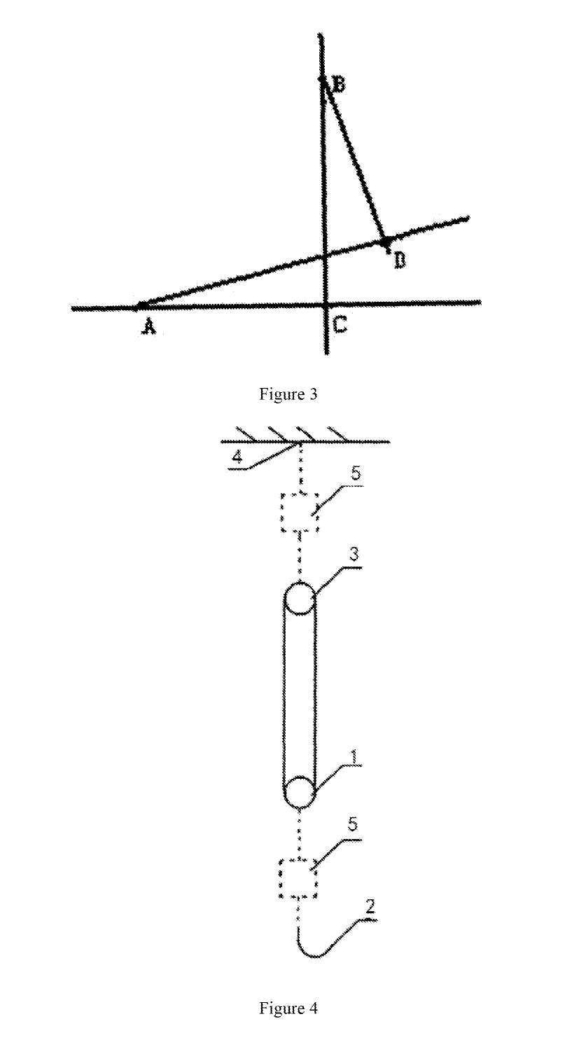

### DETAILED DESCRIPTION OF THE PREFERRED EMBODIMENT

As shown in the FIG. 4, between the movable pulley 1 of the lifting pulley assembly of crane and the hook 2 or the fixed pulley 3 and the fixed point 4 of the lifting pulley assembly of crane is cascaded a part 5 in the invention, and mounted on a detection device and a monitoring device of hook angle on the part 5. There are some preferred embodiments as follow:

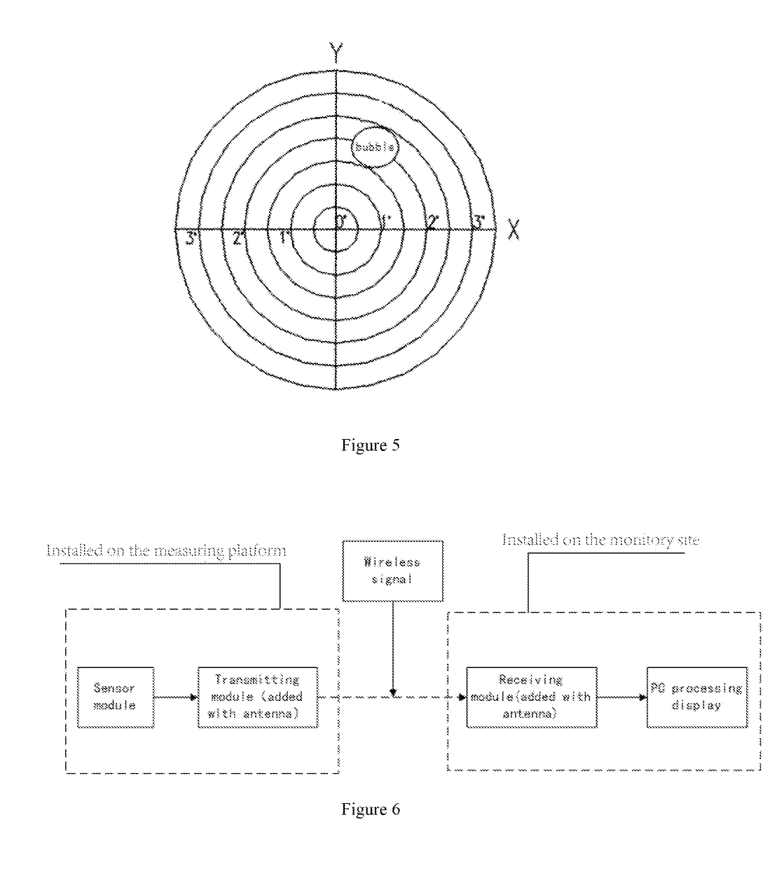

A universal level instrument detection device of hook angle, FIG. 5 is a special bubble formula universal level instrument of hook angle with real-time displaying, according to the follow description:

(1) The both sides of the fender of the lifting pulley assembly of the mast crane have increased 20 cm, and the both sides of the fender make of glass, while on the upside of the fender set up a hanger shaft to install the rings, the rings is used the shackle joint with the fixed point of the lifting ear of the lifting pulley assembly of crane.

(2) In the inside of the vacant position of fender mounted a platform, which is to satisfy the platform plane is the horizontal plane when the hook angle is 0 degree; and establish the cross-vertical coordinates in the center of the platform plane, and arrange a universal level instrument for detecting the dip angle of the platform plane with respect to the horizontal plane.

A universal level instrument motoring device of the hook angle, according to the follow description:

(1) The both sides of the fender of the lifting pulley assembly of the mast crane have increased 20 cm, and the both sides of the fender make of glass, while on the upside of the fender set up a hanger shaft to install the rings, the rings is used the shackle joint with the fixed point of the lifting ear of the lifting pulley assembly of crane.

(2) on the one side of the vacant position of fender mounted a platform, which satisfying the platform plane is the horizontal plane when the hook angle is 0 degree; and establish the cross-vertical coordinates in the center of the platform plane, and arrange a universal level instrument for detecting the dip angle of the platform plane with respect to the horizontal plane, and set a wireless cameras above the universal level instrument; on the other side of the vacant position of fender mounted large-capacity battery for supplying the power to the motoring device of the hook angle.

(3) In the crane operator's cab fitted with a wireless receiver and display controller matching with the wireless camera, the universal level instrument for lifting is to enlarge image, then to display the image on the screen of the monitoring positions.

A monitoring device of the hook angle with a biaxial angle sensor, according to the follow description:

(1) Firstly, the both sides of the fender of the lifting pulley assembly of crane is increased 25 cm, on bottom of the fender set up a fixed a beams, the hook is fixed to the beam by a nut and moving along the vertical axis of the neck of the hook (with a bearing), thereby widening the distance between the pulley assembly and the neck of the hook, and providing the space for loading the detection device of hook angle.

(2) Inside of the vacant position of fender mounted a platform satisfying the platform plane is the horizontal plane when the hook angle is 0 degree; and establish the cross-vertical coordinates in the center of the platform plane, and arrange a MEMS biaxial angle sensor for detecting the dimensional dip angle of the platform plane with respect to the horizontal plane, and set a wireless transmitter (comprised by the sensor module, a wireless transmitter module with antenna); on the other side of the vacant position of fender mounted large-capacity battery for supplying the power to the motoring device of the hook angle.

(3) In the crane operator's cab mounted wireless receiver, antenna, and display controller (mainly comprised by the wireless receiver module with the antenna and the PC), FIG. 6 is a block diagram of a biaxial wireless acquisition. Including four parts that is the sensor module, wireless transmitter modules, wireless receiver module and the PC. The sensor module and a wireless transmitter module (with a antenna) is mounted on the inside of the fender of the movable pulley, wireless receiver module (with a antenna) and the PC is mounted on the monitory position. Wherein the sensor module consists of biaxial angle sensor and the conditioning circuit, the wireless transmitter module is comprised by the A/D conversion section, a wireless transceiver microcontroller and a transmitter circuit, the wireless receiver module is comprised by the wireless transceiver microcontroller, a receiver circuit, and a serial circuit, the PC is mainly consisted of PC software and serial communication and LED indication circuit.

Because the value of the angle between the platform plane and the horizontal plane is equal to the hook angle, It assume α, aₓ, aₓ, respective is the hook angle of the crane or and the axial component the angle between the platform plane and the horizontal plane of the X axis and Y axis, and it can obtain that: (sin aₓ)²+(sin a_{y}) (sin a)², Also, because the hook angle is detected only within a few degrees, so it can obtain that: (y+(aₓ)+(a_{y})²≈(a)², the axial angle of the projection of the hook angle deviating from the X axis is βₓ=arctan [(a_{y})/(a_{y})], so it can process by the microcontroller, and output or display the hook angle value and the projection of the hook angle deviating from the X axis on the LCD in time.

A monitoring device of hook angle with triaxial accelerometer, according to the follow description:

(1) Firstly, the both sides of the fender of the lifting pulley assembly of crane is increased 25 cm, on bottom of the fender set up a fixed a beams, the hook is fixed to the beam by a nut and moving along the vertical axis of the neck of the hook (with a bearing).

(2) Inside of the vacant position of fender mounted a platform satisfying the platform plane is the horizontal plane when the hook angle is 0 degree; and establish X, Y, Z-axis Cartesian coordinates in the center of the platform plane, install a triaxial accelerometer, and arrange a device for processing the measured signal and the wireless transmitting, and also comprising a information processing module using the SCM to achieve the acquisition and solution of sensor signal, then sends the message by the data transmission module. on the other side of the vacant position of fender mounted large-capacity battery for supplying the power to the motoring device of the hook angle.

The measured value of each axis of the triaxial accelerometer mounting on the object slowly moving along the hook can be approximated that is the component of each axis of the gravitational acceleration g, according to the principle of space vector synthesis the aₓ and a_{y} is respectively the dip angle of the X axis and Y axis that is calculated to be:

$${α}_{x} = arcsin \frac{{g}_{x}}{\sqrt{{g}_{x}^{2} + {g}_{y}^{2} + {g}_{z}^{2}}} , \\ {α}_{y} = arcsin \frac{{g}_{y}}{\sqrt{{g}_{x}^{2} + {g}_{y}^{2} + {g}_{z}^{2}}} ;$$

in the above formula, the gₓ [symbol] g_{y} and g_{z} is the measured value of each axis of the triaxial accelerometer.

Because the value of the angle between the platform plane and the horizontal plane is equal to the hook angle, It assume α, aₓ, respective is the hook angle of the crane or and the axial component the angle between the platform plane and the horizontal plane of the X axis and Y axis, and it can obtain that: (aₓ)²+(a_{y})²≈(a)², the axial angle of the projection of the hook angle deviating from the X axis is) βₓ=arctan [(a_{y})/(a_{y})], so it can process by the microcontroller, and output or display the hook angle value and the projection of the hook angle deviating from the X axis on the LCD timely.

(3) In the crane operator's cab have mounted a receiving device comprising receiving device for receiving the status information of motion through the same transmission module and controlling the display of the LCD.

A laser monitoring device of hook angle, according to the follow description:

(1) Between the fixed pulley and the fixed point of the lifting pulley assembly of crane is cascaded a part, the part and the fixed puller are centering and fixing on the both sides of the fender, the part and the rings of the fixed point of the pulley assembly are used splicing connection and not in soldering connection, in order to guarantee the part swing with the hook during the lifting of the crane, at the same time it satisfies the part permanently installed on the platform plane in the different hook angle by the lifting force, the part is fixed the platform, which plane is the horizontal plane when the hook angle is 0 degree.

(2) Mounted the laser angle measuring instrument in swiveling connection, install a laser generator on the platform plane of the gantry crane, and in front of the laser generator fitted with a laser reflector on the columnar construction of the laser generator, and the plane of the laser reflectors is parallel to the plane of the platform. At the same time establish the Cartesian coordinates in the plane of the platform, and make the light-spot forming by the laser generator projecting to the plane of laser reflector as the origin, marked cross coordinates, and make the origin as a circle, when the angle α between the platform plane and the horizontal plane that is equal to 0.25 degrees, 0.5 degrees, 1.25 degrees, 1.5 degrees, 1.75 degrees, 2 degrees, 2.25 degrees, 2.5 degrees, 2.75 degrees, 3 degrees, 3.5 degrees and 4 degrees, and make the distance r from light-spot to the origin (r=Rtanα, R is the swivelling center to level the vertical distance) as a radius, and carve the concentric circles in the plane of laser reflector corresponding to the angle α, and mark the corresponding angle degrees, the origin is marked 0 degree.

(3) Below the plane of the laser reflector have mounted a the wireless camera, that is located on the subassembly connecting with he columnar construction of the laser generator, and the use of the power line of trolley of the gantry crane is to supply the power, and set a non-magnetic housing for protecting on the on the subassembly.

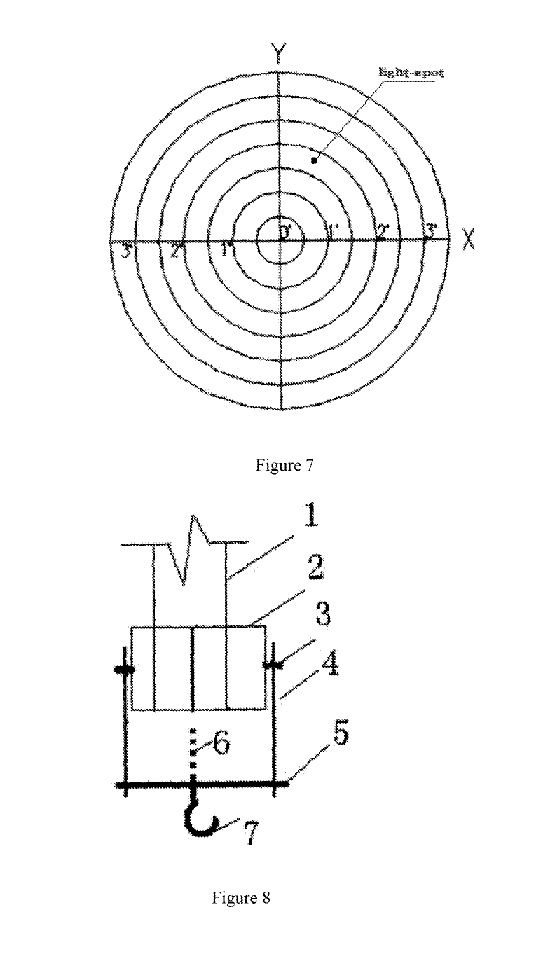

(4) In the crane operator's cab fitted with wireless receiver and display controller matching with the wireless camera, magnify the images on the plane of the laser by five and then display on the screen, and according to the light-spots in the image and the position of the concentric circles with marked angle degrees, then display the direction of the hook angel and the hook angle degrees in real-time. FIG. 7 is the laser dynamic display schematic of hook angle.

A biaxial inclinometer monitoring device of hook angle adding cooperating display, according to the follow description:

(1) Firstly, the both sides of the fender of the lifting pulley assembly of crane is increased 25 cm, on bottom of the fender set up a fixed a beams, the hook is fixed to the beam by a nut and moving along the vertical axis of the neck of the hook (with a bearing), thereby widening the distance between the pulley assembly and the neck of the hook, and providing the space for loading the detection device of hook angle.

(2) In the inside of the vacant position of fender mounted a platform, which is to satisfy the platform plane is the horizontal plane when the hook angle is 0 degree; and establish the cross-vertical coordinates in the center of the platform plane, and arrange a biaxial inclinometer with digital displaying, and install a three-channel wireless cameras switching by the remote-controller (the switch of the remote-controller is the mounted in the crane operator's cab), and the wireless cameras aim at the disk of the biaxial inclinometer with digital displaying; On the other side of the vacant position of fender mounted large-capacity battery for supplying the power to the motoring device of hook angle.

(3) In the crane operator's cab mounted three sets of the three channel receiving device matching with the wireless cameras.

(4) It can prepare a set or more receiving device matching with the wireless transmitting device and with the same switching channel in the crane operator's cab.

When the crane is lifting, each crane occupy a channel through the remote switch located in the crane operator's cab, and the receiving device located in the crane operator's cab, except for one receiving device switch to the native channel for dynamically displaying the hook angle outside of the crane operator's cab, and make the other receiving device switch to the cooperative channel for receiving the signal of the cooperative crane and dynamic display the hook angle in the screen of the crane operator's cab. The receiving device is provided on the monitor location of the lifting with co-party, or provided on the monitor location of the crane or other machinery without co-party display. Each crane is set up a wireless transmitting device and its support of the receiving device according to the monitoring device of the hook angle with co-party display, except for the normal operation of each crane, but can be used for the crane to lifting adding the co-party display.

Because the value of the angle between the platform plane and the horizontal plane is equal to the hook angle, It assume α, aₓ, a_{y} respective is the hook angle of the crane or and the axial component the angle between the platform plane and the horizontal plane of the X axis and Y axis, and it can obtain that: (aₓ)²+(a_{y})²≈(a)², the axial angle of the projection of the hook angle deviating from the X axis is βₓ=arctan [(a_{y})/(a_{y})], Therefore, the inclination of the X axial and Y axial is processing by the microcontroller, and display the hook angle and the angle between the platform plane and the X axis in time.

Thus when lifting, it can display the biaxial inclination detecting by the biaxial inclinometer monitoring device, the hook angle and the angle between the horizontal projection of the hook angle and the X axis angle, in addition to display on the outside of the crane operator's cab, simultaneous display on operator's cab of the co-party and the position of the guarding for lifting.

The monitoring device of the hook angle and the magnetic azimuth, according to the follow description:

(1) Firstly, the both sides of the fender of the lifting pulley assembly of the fluid crane is increased 30 cm, on bottom of the fender set up a fixed a beams, the hook is fixed to the beam by a nut and moving along the vertical axis of the neck of the hook (with a bearing), thereby widening the distance between the pulley assembly and the neck of the hook, and providing the space for loading the detection device of hook angle.

(2) On the vacant position of the inside of the fender have fixed a upper platform and a lower platform, which plane are horizontal plane when the hook angle is 0 degree; the upper platform and the lower platform are horizontal plane and parallel to each other, in the centre of the surface of the lower platform is set up the three-axis Cartesian coordinates, and mounted a three-axis accelerometer; in centre of the upper surface of the platform is set up a three-axis Cartesian coordinates, and install a three-axis magnetometer; the Z axis of the three-axis accelerometer and three-axis magnetometer lies on a straight line, the X axis and the Y axis of the three-axis accelerometer and three-axis magnetometer parallel to each other. On the other side of the vacant position of fender mounted large-capacity battery for supplying the power to the motoring device of hook angle.

The inclination angle from the X-axis and Y-axis to the horizontal plane respectively reflects the component of hook angle in the X axial and Y axial. The measured value of each axis of the triaxial accelerometer mounting on the object slowly moving along the hook can be approximated that is the component of each axis of the gravitational acceleration g, according to the principle of space vector synthesis the aₓ and a_{y} is respectively the dip angle of the X axis and Y axis that is calculated to be:

$${α}_{x} = arcsin \frac{{g}_{x}}{\sqrt{{g}_{x}^{2} + {g}_{y}^{2} + {g}_{z}^{2}}} , \\ {α}_{y} = arcsin \frac{{g}_{y}}{\sqrt{{g}_{x}^{2} + {g}_{y}^{2} + {g}_{z}^{2}}} ;$$

In the above formula, the gₓ [symbol] g_{y} and g_{z} is the measured value of each axis of the triaxial accelerometer.

The three-axis magnetometer can be output the current magnetic field intensity values of three-axis in the three-dimensional space with two of two orthogonal, the rotation angle of the hook is determined by three-axis magnetometer, the rotation angle can be calculated by the following formula:

$$φ = θ arctan \frac{{Y}_{H}}{{X}_{H}} ;$$

In the formula, the X_{H} and Y_{H} is the magnetic field intensity values of the X axis and the Y axis measured by the three-axis magnetometer.

Is to take the initial angle of the direction of magnetic north, it may be determined the rotation angle with respect to the geomagnetic North Pole after the hook lifting (make the rotation angle through the error compensation due to the surrounding magnetic interference).

Make the three-axis accelerometer as the angle sensor of the inclination, the type of the three-axis accelerometer is ADXL312, the type of the three-axis magnetometer is HMR430F149, The measured signal is transmitted by the wireless transmitter, through the signal processing module of the microcontroller MSP430F149 for signal acquisition and calculating, of the sensor, and send the measured signal by the data transmission module.

(3) In the crane operator's cab have mounted a receiving device comprising receiving device for receiving the status information of motion through the same transmission module and controlling the display of the LCD.

Thus the crane operator's cab can be displayed hook angle and (in the direction of magnetic north initial angle) the azimuth in real-time, and observed the electronic compass scale setting up in operator's cab, orientation evident.

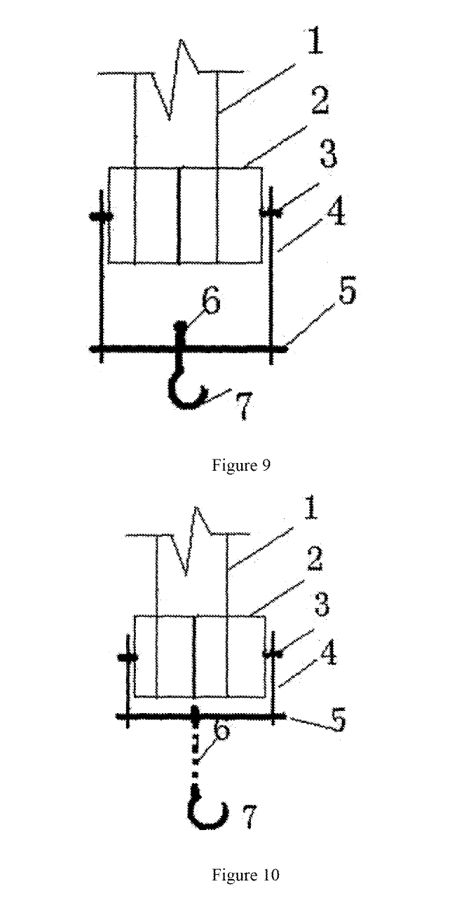

Should be noted that the foregoing is a preferred embodiment of the present invention, to those of ordinary skill, a number of changes and modifications according to the present invention shall also be considered as the scope of the invention. Now take the FIGS. 8-10 of the schematic view of the movable pulley and the assembly for instance, in the figures the label 1 is a lifting rope, the label 3 is the pulley shaft 3, after increasing the same amount on the both sides of the fender 4, the inner of the fender is not provided angle measuring instrument, and increasing the length of the hook stalk (the dotted line in the FIG. 8), and the angle measuring instrument is set on the increased hook stalk; or as shown in FIG. 9, on the end portion of hook stalk is provided the angle measuring instrument; or as shown in FIG. 10, the hook stalk 6 is increased along the beam 5 mounting on the hook, then the angle measuring instrument is installed on the increased length of the hook stalk (the dotted line in the FIG. 10), it can be considered that “between the hook and movable pulley is cascaded a part” and the end of the part is fixedly connected with the hook, the other end of the part is fixed on the beam 5 by a nut, and the part can be rotated in the vertical axis of the hook stalk. since the rotation of the hook, it impact the stress of the hook, it can be considered that the angle measuring instrument mounting on the increased hook stalk or on both inner sides of the fender is equivalent. In terms of the installed measuring instrument, such as Earth's magnetic field measuring instrument for geomagnetic sensor, flux gate sensors, Hall sensors, magnetic sensors, etc. azimuth angle measuring instrument for angle sensor, gyroscope, universal electronic level, or a combination of test platform loft angle measuring instrument and so on, especially the universal angle measuring instrument, biaxial angle measuring instrument, triaxial angle measuring instrument or will be used for angle measurement and a combination of different types of instruments, that can be used to dynamically detect the inclination angle of the platform plane to the horizontal plane, of course, the specific selection should be considered the technically feasible and more determined on the economy.

1. A detection device of the hook angle, which is used for a crane, comprising:
at least one angle measuring instrument:
a part connected between a movable pulley of a lifting pulley assembly of the crane and a hook or between a fixed pulley and a fixed point of the lifting piney assembly of the crane;
a platform fixed on the part, wherein a plane on the platform is horizontal when the hook angle is 0 degree, so that an action line of a lifting force of the lifting pulley assembly through the hook is perpendicular to the platform under the different angles of the hook;
wherein the plane on the platform is horizontal when the hook angle is 0 degree, wherein the platform is fixed on the part; wherein the angle measuring instrument is configured to detect the tilt angle of the platform relative to the horizontal platform and disposed on the platform.

2. The detection device of the hook angle: according to claim 1, wherein an end of the part is firmly connected to the two side fenders of the movable pulley or the fixed pulley.

3. The detection device of the hook angle: according to claim 2, wherein the part is connected between the fixed pulley and the fixed point of the lifting pulley assembly; wherein when the end of the part is fixed to the two side fenders of the fixed pulley, the two side fender of the movable pulley increases the same length, wherein the platform, which is horizontal when the hook angle is 0 degree, is fixed on a vacant space located between the inner sides of the lengthened fenders; wherein the angle measuring instrument is disposed on the platform.

4. A monitoring device of the hook angle, Which is used for the cranes, comprising:
at least one angle: measuring instrument,
a wireless transmitting device which is used to install a detection device of the hook angle and transmit the signal of the hook angle,
a plurality of receiving control devices which are mounted on a crane operator's cab for receiving and processing the wireless signal and displaying the hook angle;
wherein a part is connected between a movable pulley of a lifting pulley assembly of the crane and a hook or between a fixed pulley and a fixed point of the lifting pulley assembly of the crane, which meets the requirement that a plane of a platform on the part is horizontal when the hook angle is 0 degree, so that an action line of a lifting force of the pulley assembly through the hook is perpendicular to the plane of the platform under the different angles of the hook; wherein the plane of the platform, which is horizontal when the hook angle is 0 degree, wherein the platform is fixed on the part; wherein the angle measuring instrument is configured to detect the tilt angle of the platform relative to the horizontal platform and disposed on the platform.

5. The monitoring device of the hook angle according to claim 4, wherein an end of the part is fixed to two side fenders of the movable pulley or the fixed pulley.

6. The monitoring device of the hook angle according to claim 5, wherein the part is cascaded between the fixed pulley and the fixed point of the lifting pulley assembly: wherein when the end of the part is firmly connected to the two side fenders of the fixed pulley, the two side fender of the movable pulley increases the same length, wherein the plane of the platform is horizontal when the hook angle is 0 degree, wherein the platform is fixed on a vacant space located between the inner sides of the lengthened fenders: wherein a Cartesian coordinates is set the center of the platform: wherein the angle measuring instrument for detecting the tilt, angle of the platform relative to the horizontal plane of the platform, the wireless transmitting, device for transmitting and processing the signal of the hook angle, and a battery for supplying the power to the wireless transmitting device are disposed on the platform.

7. A detection device of the hook angle inside of the fender of the movable pulley, which is used for the crane, comprising;
at least one angle measuring, instrument, once two side fenders of the movable pulley increases the same length;
a platform is fixed on a vacant space located between the inner sides of the lengthened fenders,
wherein the a plane of the platform is horizontal when the hook angle is 0 degree;
wherein a Cartesian coordinates is set on the center of the platform: wherein the angle measuring instrument for detecting the tilt angle of the platform relative to the horizontal plane of the platform is disposed on the platform.

8. The detection device of the hook angle inside of the fender of the movable pulley according to claim 7, wherein a universal level instrument for detecting the tilted angle of the plane of platform with respect to the horizontal plane, or a biaxial angle sensor for detecting the two-dimensional tilted angle of the plane of platform with respect to the horizontal plane, or a triaxial angle sensor for detecting the three-dimensional tilted angle of the plane of platform with respect to the horizontal plane, or a laser device combination of angle measuring instrument for detecting the tilted angle: of the plane of platform with respect to the horizontal plane is provided on the platform.

9. The monitoring device of the hook angle inside of the fender of the movable pulley, which is used for the crane, comprising:
at least one angle measuring instrument,
a wireless transmitting device which is used to install a detection device of the hook angle and transmit the signal of the hook angle,
a plurality of receiving control devices which are mounted on a crane operator's cab for receiving and processing the wireless signal and displaying the hook angle:
once two side fenders of the movable pulley increases the same length, a platform is fixed on a vacant space located between the inner sides of the lengthened fenders, wherein a plane of the platform is horizontal when the hook angle is 0 degree;
wherein a Cartesian coordinates is set on the center of the platform: wherein the angle measuring instrument for detecting the tilt angle of the platform relative to the horizontal plane of the platform, the wireless transmitting device for transmitting and processing the signal of the hook angle, and a battery for supplying the power to the wireless transmitting device are disposed on the platform.

10. The monitoring device of the hook angle inside of the fender of the movable pulley according to claim 9, wherein a universal level instrument for detecting the tilted angle of the plane of platform with respect to the horizontal plane, or a biaxial angle sensor for detecting the two-dimensional tilted angle of the plane of platform with respect to the horizontal plane, or a triaxial angle sensor for detecting the three-dimensional tilted angle of the plane of platform with respect to the horizontal plane, or a laser device combination of angle measuring instrument, for detecting the tilted angle of the plane of platform with respect to the horizontal plane is provided on the platform.

11. A monitoring device of the hook angle added with the cooperating party's display, which is used for the crane, comprising:
at least one angle measuring instrument, installed with a detection device of the hook angle;
a wireless transmitting device for transmitting the signal of the hook angle; and
a plurality of receiving devices are mounted in a crane operator's cab, which receive and process the wireless transmitted signals and dynamically displays the hook angles;
wherein once two side fenders of the movable pulley increases the same length, a platform is fixed on a vacant space located between the inner sides of the lengthened fenders, Wherein a plane of the platform is horizontal when the hook angle is 0 degree: wherein a Cartesian coordinates is set on the center of the platform; wherein the angle measuring instrument for detecting the tilt anile of the platform, relative to the horizontal plane of the platform is disposed on the platform; wherein a set of two channel remote switching wireless transmitting device, or a set of three channel remote switching wireless transmitting device, and a battery for supplying power to the device are disposed on the platform; and
wherein two sets of two channel switching receiving control device matching with the two channel remote switching wireless transmitting device; or three sets of three channel switching receiving control device matching with the three channel remote switching wireless transmitting device are installed in the crane operator's cab.

12. The monitoring device of the hook angle added with the cooperating party's display according to claim 11, wherein a remote switching is installed in the crane operator's cab, wherein the wireless transmitting device is a wireless camera, wherein the angle measuring instrument is digital display biaxial inclinometer, or digital display universal level meter.

13. The monitoring device of the hook angle added with the cooperating party's display according to claim 11, wherein: when the crane is lifting, each crane occupy a channel through the remote switching located in the crane operator's cab, and the receiving control device is located in the crane operator's cab, besides one set of the receiving control device switch to the native channel for dynamically displaying the hook angle outside of the crane operator's cab, and make the other receiving control device switch to the cooperating party's channel for receiving the signal of the cooperating party's crane and dynamically display the hook angle inside of the crane operator's cab.

14. A monitoring device of the hook angle and the magnetic azimuth, which is used for the crane, comprising:
at least one angle measuring instrument;
a detection device of hook angle; and
a wireless transmitting device for transmitting the signal of the hook angle and the magnetic azimuth, and
a receiving control device is mounted in the crane operator's cab for receiving and processing the wireless signal and displaying the hook angle and the magnetic azimuth;
wherein once two side fenders of the movable pulley increases the same length, a platform is fixed on a vacant space located between the inner sides of the lengthened fenders, wherein a plane of the platform is horizontal when the hook angle is 0 degree: wherein a Cartesian coordinates is set on the center of the platform; wherein an angle measuring instrument and a geomagnetic field measuring instrument for detecting the inclination of the plane of platform to the horizontal plane are disposed on the platform; and wherein a wireless transmitting device for transmitting and processing the measured signal and a battery to supply the power of the wireless transmitting device are disposed on the platform.

15. The monitoring device of the hook angle and the magnetic azimuth according to claim 14, wherein a upper platform and a lower platform are fixed on the vacant space on the two lengthened side fender, wherein a plane of the platform is horizontal when the hook angle is 0 degree; the upper platform and the lower platform are horizontal and parallel to each other; wherein a three-axis Cartesian coordinates is set up on the center of the surface of the lower platform, and a three-axis accelerometer is installed on the center of the surface of the lower platform; wherein a three-axis Cartesian coordinates set up on the center of the upper surface of the platform, and a three-axis magnetometer is install on the center of the upper surface of the platform; wherein the Z axis of the three-axis accelerometer and three-axis magnetometer lies on a straight line, the X axis and the Y axis of the three-axis accelerometer and three-axis magnetometer parallel to each other.

16. A crane, wherein: comprising the detection device of the hook angle according to claim 1.

17. A crane, wherein: comprising the monitoring device of the hook angle according to claim 4.

18. A crane, wherein: comprising the detection device of the hook angle inside of the fender of the movable pulley according to claim 7.

19. A crane, wherein: comprising the monitoring device of the hook angle inside of the fender of the movable pulley according to claim 9.

20. A crane, wherein: comprising the monitoring device of the hook angle added with the cooperating party's display according to claim 11.

21. A crane, wherein: comprising the monitoring device of the hook angle and the magnetic azimuth according to claim 14.
